(19) United States
(12) Patent Application Publication
(10) Pub. No.: US 2013/0204543 A1
(43) Pub. Date: Aug. 8, 2013

(54) Hull Inspection System

(71) Applicants: Ola Pettersson, Orebro (SE); Anders Bagge, Linkoping (SE)

(72) Inventors: Ola Pettersson, Orebro (SE); Anders Bagge, Linkoping (SE)

(73) Assignee: SAAB AB, Linkoeping (SE)

(21) Appl. No.: 13/697,228

(22) PCT Filed: May 10, 2010
(86) PCT No.: PCT/SE10/50509

§ 371 Date: Jan. 14, 2013

(51) Int. Cl. G01M 10/00

(52) U.S. Cl. CPC G01M 10/00
USPC 702/39; 702/35; 702/40

(57) ABSTRACT

A hull inspection system useable for inspecting a hull of a maritime vessel passing a water volume at a first velocity, the system comprising: pulse emitting means, for being placed in the water volume and for emitting energy pulses into said water volume; sensing means, for being placed in the water volume, and being connected to the pulse emitting means, for sensing and measuring travelling time of energy pulses reflected by the passing vessel; a sensor data processing unit; connected to the sensing means, for processing data from the sensor means; a vessel data furnishing unit, connected to the sensor data processing unit, for providing vessel velocity data to the sensor data processing unit; wherein a three-dimensional representation of the hull of the maritime vessel is created based on data acquired by a procedure involving combination of data from a number of consecutive sensing means linear scans, and wherein the consecutive linear scans are acquired at consecutive moments in time, thereby enabling creation of a three dimensional representation of the hull.

### TECHNICAL FIELD

The present invention relates to harbour security systems and in particular to a system for generating a 3-D image from linear sensor data suitable for use in detection of smuggled goods and terrorist explosive charges secretly attached on the outside of a ship's hull below the waterline.

### BACKGROUND

Today, many of the world's shipping companies experience an increased risk of their ships being secretly used by smugglers or terrorists. For example there is a risk that a smuggler secretly attaches an object, like a smuggle canister, to a ship while it is in one port, and secretly removes it while it is in another. Another example includes a terrorist attaching an object like an explosive charge to a ship to be used for a terrorist attack directed to that ship or to another ship. Attachment of such objects is done below the waterline to deceive authorities. There is a problem to inspect the underwater body of a ship, since manual inspection by divers is laboriously, and may be dangerous to the divers. It is also often expensive and time consuming. Some efforts have been made to solve this or a similar problem as is disclosed in the prior art identified and briefly discussed below.

U.S. Pat. No. 6,850,173 discloses a waterway shield system comprising a plurality of autonomous underwater nodes wherein each underwater node comprises acoustic detectors which may comprise horizontal and/or vertical acoustic arrays which may be directly mounted thereto or extend outwardly there from. Each underwater node comprises an acoustic modem for transmitting high resolution acoustic data to a gateway node that provides a connection to a surface system and a network of other underwater nodes in other waterways. The data from the underwater nodes may be utilized to produce acoustic attribute data for hulls of ships in the waterways. An acoustic database is provided that compiles the predetermined acoustic attribute data for a variety of ships and other entities thereby providing previously stored identifying means. The acoustic database is utilized in conjunction with one or more databases of other physical attributes of ships or other objects to thereby provide an automated identification process.

U.S. Pat. No. 7,072,244 discloses a multi beam acoustic transducer array system for producing colour enhanced, three dimensional, high resolution images of a ship's underwater hull, wherein the acoustic transducers can be mounted in orthogonal pairs, each pair being positioned opposite from another pair within a shipping channel. The array can be utilized either in a stationary configuration within a controlled shipping lane or suspended in the water column from a mobile support vessel, with at least one array being orthogonally mounted and suspended in the water column from the mobile support vessel, wherein the mobile configuration obviates the need for multiple orthogonal arrays, for purposes of performing acquisition and imaging of a ship's hull. Each orthogonal array consists of a first transducer transmitting sonar pulses along a horizontal plane and a second transducer transmitting sonar pulses along a vertical plane, such that the two beaming sonar pulses are orthogonal, thereby providing optimal coverage. The system should be able to render accurate images quickly so that human analysis can be conducted quickly such that suspicious vessels can be segregated from those not posing any terrorist risk or violating any laws of a sovereign nation's port of entry.

### SUMMARY OF THE INVENTION

It is realised by the inventors that there is no cost effective, easy to use system on the market today for performing security scanning of an underwater portion of the hull of each ship arriving or departing to/from a modern busy port.

Therefore, it is an object of the present invention to provide a cost effective, easy to use, robust system that is able to acquire and create an image of a ship's hull when the ship is passing a waterway at a speed, and which image is suitable for a human operator and/or a machine, to analyse and interpret, and which image is of sufficient resolution and image quality to enable detection of possible harmful objects such as smuggle canisters or explosive charges.

This is solved by a system according to claim 1. The inventive concept is to use a linear sensor component such as a sonar, or a lidar, to scan a ship's underwater body as it passes by the sensor, and to use ship velocity data to achieve correct resolution and aspect ratio of a created image. The inventive concept also includes arranging a normal vector of a scanning plane in certain angles with respect to certain reference directions.

In particular the invention relates to a hull inspection system useable for inspecting a hull of a maritime vessel passing a water volume at a first velocity, the system comprising:
pulse emitting means, for being placed in the water volume and for emitting energy pulses into said water volume;
sensing means, for being placed in the water volume, and being connected to the pulse emitting means, for sensing and measuring travelling time of energy pulses reflected by the passing vessel;
a sensor data processing unit; connected to the sensing means, for processing data from the sensor means;
a vessel data furnishing unit, connected to the sensor data processing unit, for providing vessel velocity data to the sensor data processing unit;
   wherein a three-dimensional representation of the hull of the maritime vessel is created based on data acquired by a procedure involving combination of data from a number of consecutive sensing means linear scans, and wherein the consecutive linear scans are acquired at consecutive moments in time, thereby enabling creation of a three dimensional representation of the hull.

Further, a first scanning direction may be obtained by the passing of the maritime vessel by the position of the sensing means at the first velocity, and wherein a second scanning direction, different from the first scanning direction, may be obtained by arranging the sensor unit to scan in the second scanning direction. A slice scanning plane, in which slice scanning plane the sensing is performed by the sensing means in the second scanning direction, may be arranged to have a normal vector being parallel with a first velocity vector of the first velocity.

The slice scanning plane may be arranged to have a normal vector deviating from parallel with the first velocity vector with a first angle being up to 80 degrees in a first direction, and up to 80 degrees in a second direction.

A projection of the normal vector of the slice scanning plane in the sea surface plane may be arranged to form a turn angle (φ) to the projection of the (intended) velocity vector in the sea surface plane, the turn angle may be arranged to be in the interval of 0 to 30 degrees.

The turn angle (φ) may be in the interval of 15 to 25 degrees.

A tilt angle (θ) between the velocity vector, and the projection of the normal vector of the slice scanning plane in a vertical plane parallel to the velocity vector, may be arranged to be in the range of 0 to 30 degrees.

The tilt angle (θ) may be in the range of 15 to 25 degrees.

The emitter means and sensor means may be arranged together forming a sensor unit. The sensor unit may be a sonar. The sensor unit may alternatively be a lidar.

The system may also comprise:
a presentation unit; for presenting processed data.

The system wherein a representation of the water surface and the hull is built on a set of range values proportional to energy transit times from a energy pulse emitter to the water surface or hull surface, and back, and detected as strongest echo in each direction of a family of directions in a slice scanning plane.

Further, the invention relates to a method for inspecting a hull of a maritime vessel passing a water volume at a first velocity, the method comprising the following steps:
emitting energy pulses into said water volume with the aid of an emitting means;
sensing and measuring travelling time of energy pulses reflected by the passing vessel with the aid of sensor means;
processing data from the sensor means;
providing vessel velocity data;
creating a three-dimensional representation of the hull of the maritime vessel based on data acquired by a procedure involving a combination of data from a number of consecutive sensing means linear scans, and wherein the consecutive linear scans are acquired at consecutive moments in time.

A first scanning direction may is obtained by the passing of the maritime vessel by the position of the sensing means at the first velocity, and a second scanning direction, different from the first scanning direction, is obtained by arranging the sensor means to scan in the second scanning direction.

A slice scanning plane is arranged where sensing is performed by the sensing means in the second scanning direction, and a normal vector of which is arranged to be parallel with a first velocity vector of the first velocity.

The method wherein a slice scanning plane, in which slice scanning plane the sensing is performed by the sensing means in the second scanning direction, the slice scanning plane being arranged to have a normal vector deviating from parallel with the first velocity vector with a first angle being up to 80 degrees in a first direction, and up to 80 degrees in a second direction.

The method wherein the projection of the normal vector of the slice scanning plane in the sea surface plane is arranged to form a turn angle (φ) to the projection of the velocity vector in the sea surface plane, the turn angle being arranged to be in the interval of 0 to 30 degrees.

The method wherein the turn angle (φ) is in the interval of 15 to 25 degrees.

The method wherein a tilt angle (θ) between the velocity vector, and the projection of the normal vector of the slice scanning plane in a vertical plane parallel to the velocity vector, is arranged to be in the range of 0 to 30 degrees.

The method wherein the tilt angle (θ) is in the range of 15 to 25 degrees.

The method wherein the emitter means and sensor means are arranged in close proximity forming a sensor unit. The sensor unit may be a sonar. The sensor unit may alternatively be a lidar.

The method also comprising the step of:
presenting processed data on a presentation unit.

The method wherein a representation of the water surface and the hull is built on a set of range values proportional to energy transit times from a energy pulse emitter to the water surface or hull surface, and back, and detected as strongest echo in each direction of a family of directions in a slice scanning plane.

### BRIEF DESCRIPTION OF THE DRAWINGS

FIG. 1 shows a system overview of a hull inspection system.

FIG. 2 shows on-shore units of the system of FIG. 1.

FIG. 3 is a sonar image of an empty water mass.

FIG. 4 is a schematic view from behind of a shipping channel with sonar field of view and passing vessel.

FIG. 5 is the shipping channel of FIG. 4 with a side view of the passing ship.

FIG. 6 is a two-dimensional sonar image of a ship's hull and defining a polar coordinate system.

FIG. 7 is a two-dimensional sonar image of a ship's hull.

FIG. 8 is a schematic image showing how consecutive two-dimensional sonar images are used to create a concise three-dimensional representation of a ship's hull.

FIG. 9 is a sonar image of a ship's hull with an attached object.

FIG. 10 is a flowchart of a method for pre-processing of sensor data in a hull inspection system.

FIG. 11 is a flowchart of a method for hull detection and 3D modelling of the hull using pre-processed sensor data.

FIG. 12 is a schematic illustration in perspective view for defining planes and directions in a sea volume.

FIG. 13 is a schematic view from above of a ship passing a sensor.

FIG. 14 is a schematic view from above to illustrate a definition of a sensor turn angle.

FIG. 15 is a schematic view from the side to illustrate a definition of a sensor tilt angle.

### DETAILED DESCRIPTION

### Definitions

For the purpose of the present application, the following definitions apply A “linear sensor” is a sensor that at a given frame of time is able to produce a two-dimensional representation of a sensed area, but not being able to produce a three-dimensional representation.

A “sensor” is a device able to sense an absolute value or a change in a value of a physical quantity. For the purpose of the present invention the physical quantity may be sound intensity or light intensity and the sensor may be an active sonar (sound navigation and ranging) or a lidar (light detection and ranging), which both are ranging sensors.

A “potential object” is an image or representation of something that is considered by someone or something to be a candidate for being an actual non-harmful or harmful object.

An “actual object” is an object existing in the real world of objects associated to a ship's hull. An actual object may be non-harmful, e.g. inlets, cathodes, fins; or harmful, e.g., smuggle canisters, explosive charges.

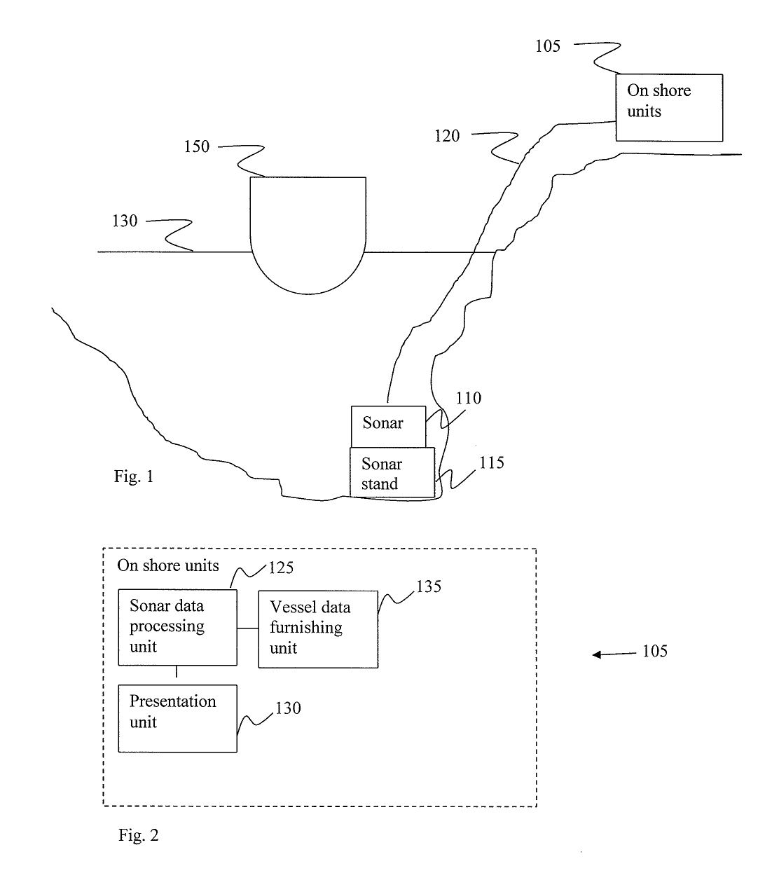

FIG. 1 shows a system overview of a hull inspection system. FIG. 2 shows on-shore units of the system of FIG. 1. The system comprises:
a sonar unit 110;
a sonar stand 115;
an underwater cable 120;
a number of on-shore units 105 comprising:
a sonar data processing unit 125;
a presentation unit 130, and;
a vessel data furnishing unit 135,

The sonar unit comprises an emitter for emitting sound pulses into the water volume, and also a sensor for sensing the reflected sound pulses, and measuring travelling times for the pulses, as is known from the art of sonar technology. The sonar is of the linear type, as defined above, forming a scanning plane. The sonar stand 115 is a mechanical construction forming a stable platform for the sonar unit 110. It is designed to be placed at the sea bottom of the seaway and is designed to accommodate the sonar unit 110, such that the sonar unit 110, which is designed to obtain sonar data, is arranged at a position to obtain sonar data of a maritime vessel passing the seaway. The sonar data processing unit 125 processes sonar data from the sonar unit. The underwater cable 120 connects the sonar unit and the sonar data processing unit 125. The sonar data is acquired by a two-dimensional scanning procedure wherein a first scanning direction is obtained by the passing of the maritime vessel by the position of the sonar unit 110 at a first velocity. A second scanning direction is obtained by letting the sonar unit scan in the scanning plane. The scanning plane is arranged as follows: A first largest angle between a normal vector of the scanning plane and a velocity vector of the first velocity is in the interval of 0 to 60 degrees. A discussion on suitable angles will follow further below. The sonar data processing unit 125 is devised to use vessel velocity data from the vessel data furnishing unit 135 and further devised to combine this maritime vessel velocity data with the sonar data to produce a three-dimensional representation of an underwater portion of the hull of the passing maritime vessel. The sonar data processing unit 125 may be devised to send the produced three-dimensional representation to a presentation unit for presentation of an image for human interpretation. The sonar data processing unit 125 may also or alternatively be devised to compare the produced three-dimensional representation of the hull of the passing maritime vessel with a corresponding representation of said vessel's unaffected hull, and to indicate if a suspected difference is found.

The “sonar unit” mentioned in the above paragraph may instead be another suitable sensor unit, for example a “lidar unit”, and the “sonar bottom stand” a “lidar bottom stand”, and sonar data may be “lidar data” and so on.

The captain of the passing ship may be instructed to keep the first velocity at a constant value in the range of 2 to 5 knots when passing, to give the sonar enough time to scan the hull of the passing ship, resulting in good resolution in the first velocity vector direction.

For the purposes of this application it is envisaged that the velocity vector of a passing ship is in the same or almost the same direction as that of the seaway which the ship is travelling. When talking about directions and angles, the velocity vector of a passing ship can therefore be used as reference direction synonymously with the direction of the seaway, or vice versa.

### Sonar

The hull inspection system may comprise a multibeam sonar unit 110 (such as e.g: Imaginex Delta T (675 kHz), Reson SeaBat 7125-120 (400 kHz), Reson SeaBat 7125-45 (400 kHz), or BlueView MB 1350 (1350 kHz)).

In a typical setup, the sonar stand is arranged to place the sonar at a dept of 10-20 meter depth in a waterway. In a test configuration, the sonar was placed at 17 meters. Smuggle canisters and limpet mines are envisaged to be the main targets. In the test performed, the setup showed good results in providing high resolution sonar data suitable for further processing.

A second sonar unit (not shown) may be arranged at the other side of the seaway, opposite the to the first sonar unit, to provide sonar data from the opposite side of the passing ship. To reduce interference from one sonar to another, pinging and receiving may be synchronised to take place in certain time windows such that a receiving window of the second sonar is arranged to be closed to an echo signal of a ping of the first sonar, and vice versa, to avoid noise and interference from the opposite sensor.

Further, to avoid interference, the second sonar unit may be arranged to operate in a different frequency band than the first mentioned sonar unit.

As mentioned above, one embodiment may comprise a lidar unit as a linear ranging sensor, instead of the sonar unit. In such an embodiment it is of course also advantageous to arrange a second lidar unit to provide sensor data from the opposite side of the hull of the passing ship. To reduce interference the two lidar units may be arranged to send out light and receive reflected light in certain time windows, such that noise and interference originating from light sent from the other lidar unit is avoided with the aid of letting the sensor be insensitive and/or shut off at time periods when light originating from the other sensor is expected.

Also, the first and second lidar units may be arranged to use different light frequencies or different light frequency bands to avoid noise and interference from each other. In this context a first frequency of a first light source of the first lidar unit may be matched to a first light sensor of the first lidar unit, and correspondingly, a second frequency of a second light source of the second lidar unit may be matched to a second light sensor of the second lidar unit.

The use of certain time windows as described above, and use of different frequencies may be employed separately or in combination, to further reduce noise and interference.

### Sonar Data Processing Unit

The sonar data processing unit 125 may typically be placed on land some 650 m from Sensor system. This unit is devised to perform sonar data analysis and image processing in order to produce a three-dimensional image of the hull of the inspected ship.

The sonar data processing unit 125 may be a PC server running sonar data analysis software for sonar data analysis and communication with the sonar via the underwater cable 120 and the presentation unit 130. Sonar data analysis software may be divided into a number of units or components.

These components may comprise:
a sonar interface and communication component, and
an analysis component.

### Sonar Interface and Communication Component

The main task of the sonar interface component is to handle communication towards the sonar unit 110, including data acquisition as well as sonar control and sonar status monitoring. When the communicator component receives a start-scan command the communicator component sends a start message to the sonar interface component to start collecting and storing data from the sonar unit 110. The sonar interface component is arranged to continuously collect raw sonar data through an application program interface (API) given from the sonar supplier, and to store the data locally on a memory device such as a hard disk drive. This has also the advantage that the recorded data can be used offline for algorithm development, in addition to real time hull inspection.

The raw sonar data is pre-processed by beam-forming and may be translated into a common internal sonar format.

The sonar interface component is arranged to make accessible the pre-processed data such that the analysis component can use it, more about this below.

### Analysis Component

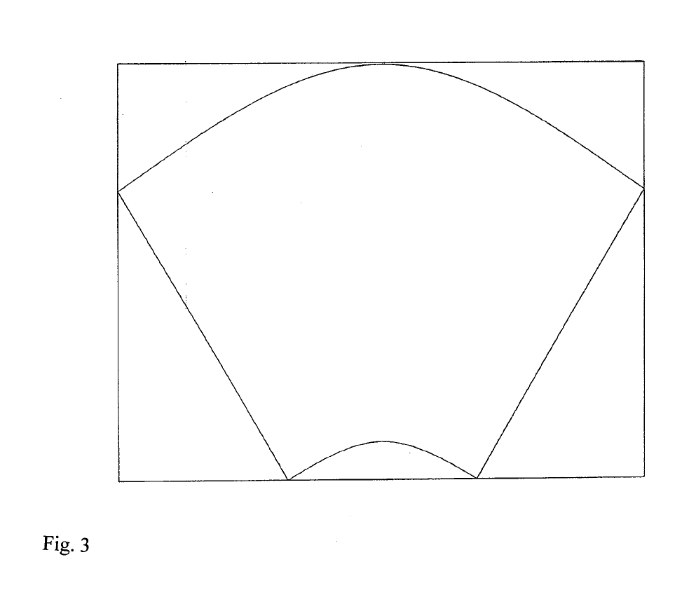

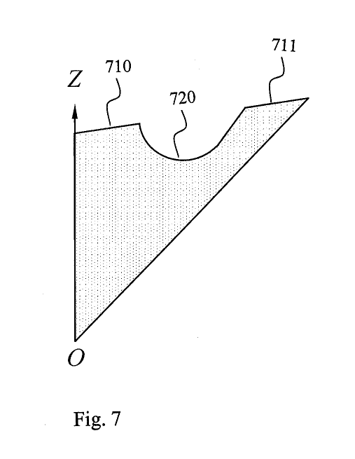

Thus, input data to an analysis algorithm of the analysis component are a set of images composed of beam formed sonar data from the sonar 110. On a low level, sonar data acquired by the receiver part of the sonar head is phase and amplitude of acoustic signals in the water volume. The beam forming process combines these data and the output is a collection of intensity values along two spatial dimensions. These two dimensional intensity values are identified via their corresponding angle and range coordinates. A single sonar image is illustrated in FIG. 3, and FIG. 7. FIG. 3 shows an empty water volume whereas FIG. 7 shows an image of a water volume with a ships hull contour 720, and a water surface line segment 710, 711 on both sides of the ships hull contour 720.

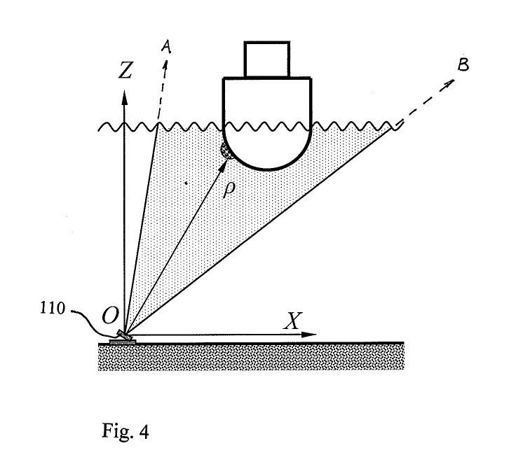

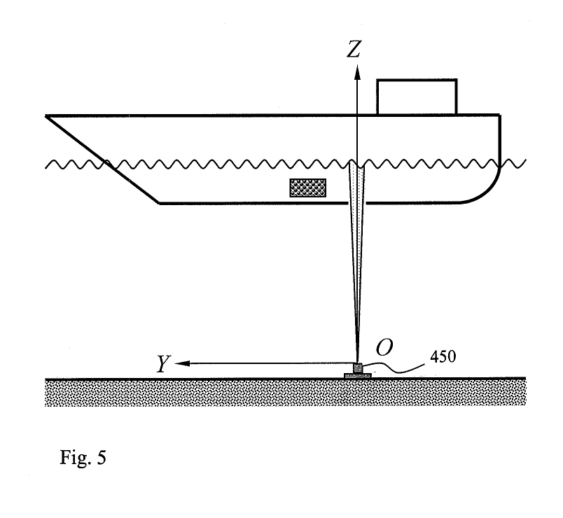

The sonar orientation may be chosen to make the sonar scan in a fan-shaped plane perpendicular to a longitudinal direction of the seaway, corresponding to the travel direction of the ship. In the following, the travelling direction of the ship is used synonymously with the longitudinal direction of the seaway (+/−180 degrees) at the point of the sensor. For the purposes of this application a reference direction A is defined as the uppermost sweep direction. A reference direction B is defined as the lowermost sweep direction. The angle between direction A and direction B is defined as the field-of-view (FOV) of the sensor. The sonar is preferably arranged such that its FOV is sufficient to cover a complete slice of the hull at a time, from port to starboard or vice versa, see illustration in FIG. 4, to create a slice image. The analysis software is arranged to combine these slice images to create a three-dimensional image of the hull as described in a later section.

### Pre-Processinq Subcomponent

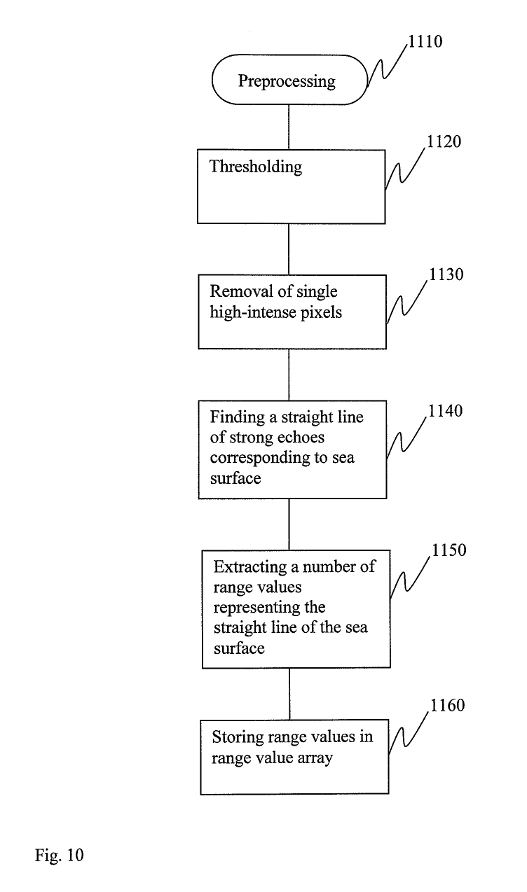

FIG. 10 is a flowchart of a method for pre-processing of sensor data in a hull inspection system. A pre-processing subcomponent of the hull inspection system is a portion of the analysis component. Inherent in the sonar image is that each intensity value in the image indicates a level of reflection of an energy pulse, such as an acoustic pulse or a laser pulse from a corresponding point in the water volume. Using active sonar, scattering occurs from small objects and this interference must be paid attention, which is done in the step of pre-processing.

Since actual hardware deviates from the ideal, the signal acquisition in sensors, A/D converters and other hardware generate noise in the sensor images. Any acoustic signal or laser signal in the scanned water volume may potentially affect the sensor image as well. For best results, such artefacts must be suppressed and that is the purpose of the pre-processing step. Each slice image, i.e., an image based on data received after a single sonar pulse or a short burst of scanning laser pulses (the latter e.g., with the aid of a mirror or prism), is subject to a truncation with a threshold value ct, so called thresholding 1120. All pixels values in the slice image I with intensity larger than the threshold value ct is kept to the value they have while the others are blanked.

$$I = \{ \begin{matrix}I , & I > {c}_{t} \\ 0 , & I \leq {c}_{t}\end{matrix}$$

The threshold value ct is preferably set for maximum noise reduction in the specific environment where the hull scan system is to be deployed. In addition, all small objects, such as single high-intensity pixels, may be removed 1130 from the threshold image as well.

There are two approaches to finding an optimal threshold value ct that is worth mentioning here. One possibility is to manually calibrate the threshold value for a maximum signal-to-noise ratio (SNR). This is defined as

ct=max_{Ct}SNR(I)

The other possibility is to automatically find a threshold value by averaging the intensities of a slice image I wherein no hull is present and multiply this value with a constant cm that render the best results.

_{Ct}=_{Cm}Ī

A reflecting sea surface can be recognized 1140 as a straight line running through a sensor image. The location of this line in the sensor image depends on the angle α between a flat sonar fan, i.e., the plume of sonar beams formed by the sonar after each sound pulse, and the sea surface. Or, in the lidar case, the fan formed by a short burst of scanning laser pulses.

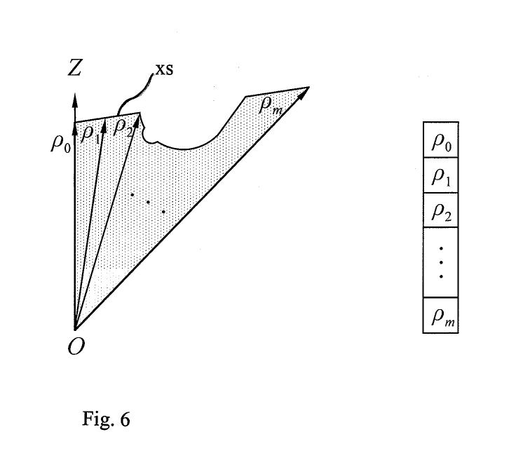

Emitting energy pulses perpendicular to the sea surface would place this line horizontally on the sonar image in FIG. 3, but the inclination of the sensor 110 as best seen in FIG. 4 will render an image more like the sensor image illustrated in FIG. 6, i.e., a line 610, 611 representing the waterline would appear slightly slanting on a monitor image or other visual representation.

The system may be provided with a connection to a vessel traffic service (VTS) system via the vessel data furnishing unit 135. By using position data from the VTS system the scanning process can be started before the ship arrives to the scanning station. Before the ship reaches the sonar view, a sea surface tracker denotes the position of the sea surface. The sea surface tracker is a unit of the analysis software. In each sonar image, the sea surface xs is represented 1150 by a number of range values ρ₀, ρ₁, ρ₂, . . . ρₘ, one for each arrow in the image illustrated in FIG. 6. The selected range values are those with the highest intensity values for each arrow. Each arrow represents a sound beam, and the length of the arrow corresponds to the time delay to the strongest echo of that particular beam which is proportional to the distance, or range, to the water surface from a sonar pulse emitter of the sonar 110.

An illustration of a range value extraction in case of sea surface reflection can be seen in FIG. 6, wherein each beam becomes associated with a range p corresponding to the range to the strongest echo in that beam direction. A stored reference sea surface is defined as the median distance x̅ₛ of ns slice images with j columns. Median filtering will reduce noise in the sea surface model and remove artefacts from the model.

### Hull Modelling Subcomponent

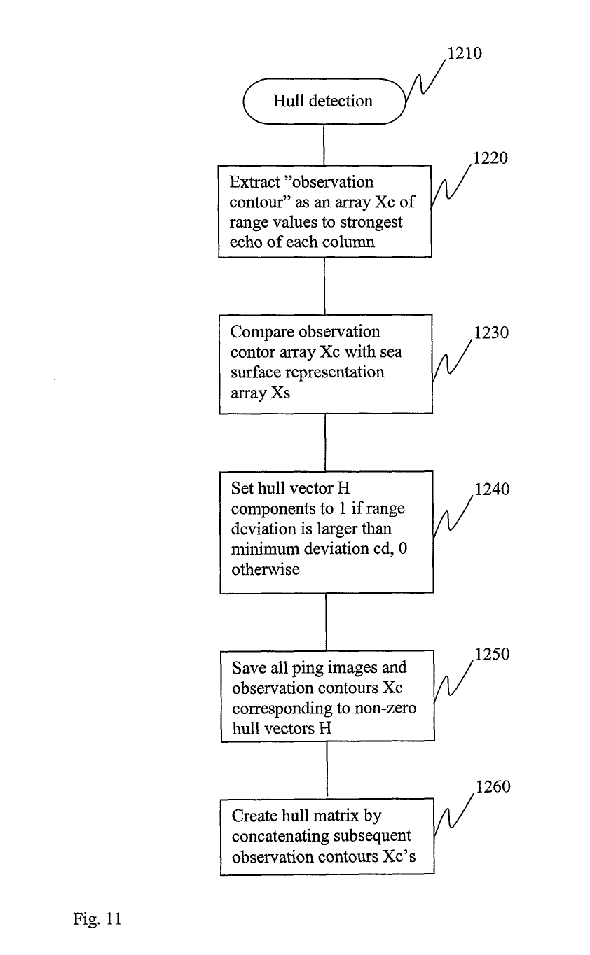

The hull inspection system may comprise machine detection of a hull, see below. FIG. 11 is a flowchart of a method for hull detection and 3D modelling of the hull using pre-processed sensor data. A hull of a passing ship may preferably be detected as a deviation from the sea surface as defined above. In other words, an abrupt increase of the sea surface derivative indicates that the hull has reached the field of view of the sensor. For every slice image I, a contour Xc is extracted 1220. In the current slice image I, iterate over a number nc of intensity values for different ranges around the last contour xc to find the range value.

There is heavy noise close to the hull and the most appropriate distance is chosen by weighing the distance and the intensity. Update xc with the new distances. Initially, xc is equal to x̅ₛ. The hull is represented by a dynamic model that is updated for each ping by iterating over Xc. Deviations from x̅ₛ are recorded according to

$$h = \{ \begin{matrix}1 , {x}_{c >} {\tilde{x}}_{s} + {c}_{d} \\ 0 , otherwise\end{matrix}$$

where cd is a constant specifying the minimum deviation to consider. In other words, the observations contour array xc is compared 1230 with the sea surface representation array xs. Hull vector components are set 1240 to 1 if range deviation is larger than minimum deviation cd, and zero otherwise. Large peaks of deviations, represented by consecutive regions of ones, are registered as hull.

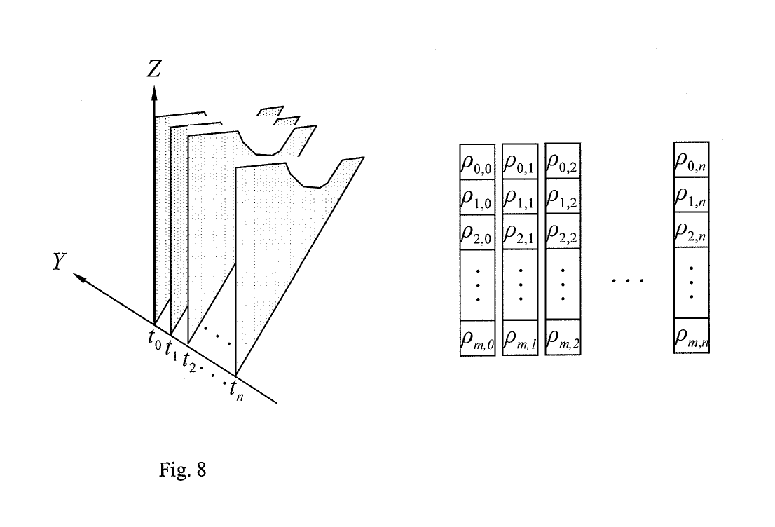

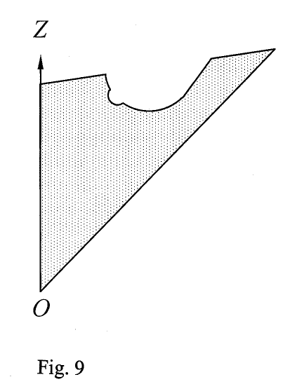

Deviations from the sea surface model in the following slice images are inspected and will be classified as a hull if certain conditions are met. A typical sensor image with a hull in the field of view is illustrated in FIG. 7. Sea surface line segments 710, 711 are seen on each side of a hull curve 720. A hull model is built up and the following hull slice images are incorporated in a hull image, see below. The hull slice images are stored along a time axis and will make up a three-dimensional model of the hull as illustrated in FIG. 8. Every range vector xc are concatenated along a time axis. Slice images of time t₀, t₁, t₂, . . . tₙ will build a three-dimensional image representation in the Y-axis direction. Each slice image represents as it is issued, when a certain point of the ship passes by the position of the sensor, a different along-hull position of the vessel and the slice image is therefore parallel to the along-hull spatial axis. By combining this with the range and along position values of each data point, a three-dimensional hull model can be presented. The process of creating a three-dimensional model is depicted in FIG. 8, wherein the notation ρm,n should be interpreted as range ρ at angle m at time n.

### Presentation Unit

The operator interacts preferably with presentation unit 130 solely. The Presentation system is basically a Vessel Traffic Services (VTS) supplied e.g. by Saab Transpondertech where the Hull Inspector is integrated as an intelligent sensor similar to, for example, cameras, or radars. The presentation subsystem may include a presentation computer, and an AIS receiver.

The presentation unit involves a computer that may comprise a networked workstation computer or laptop, and standard PC peripherals, such as mouse, screen and keyboard. At the Presentation computer the operators may have access to the maritime situation picture.

### Vessel Data Furnishing Unit

The vessel data furnishing unit could involve an AIS receiver, that is, an antenna that collects data from the Automatic Identification System (AIS). This data is used within the presentation unit in order to track ships. AIS messages include data such as:
unique ship identification;
ship's position;
ship's course, and;
ship's speed.

The International Maritime Organization's (IMO) International Convention for the Safety of Life at Sea (SOLAS) requires AIS to be fitted aboard international voyaging ships with gross tonnage of 300 or more tons, and all passenger ships regardless of size.

### Orientation of the Sensor Slice Plane

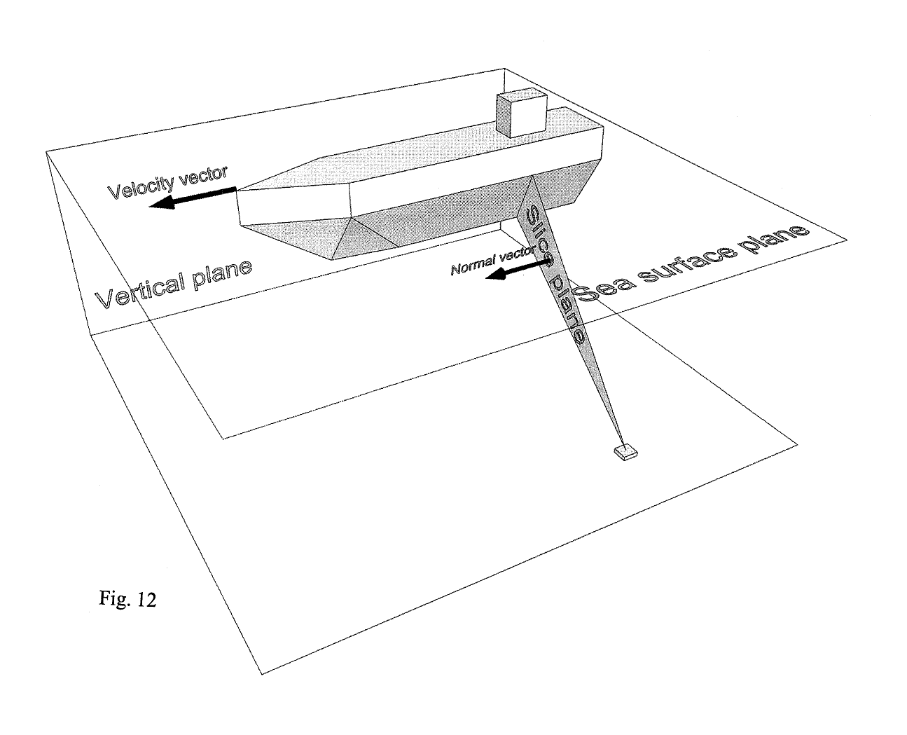

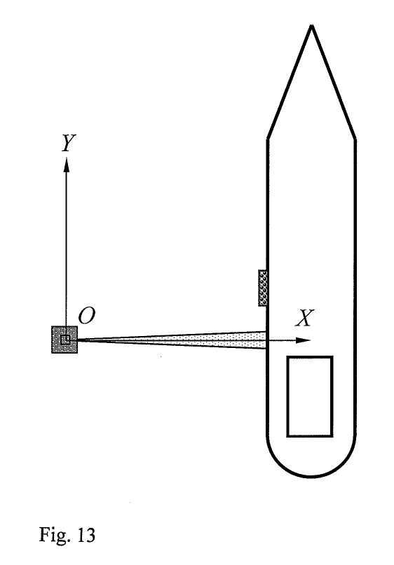

Turning now to FIGS. 12 to 15, FIG. 12 is a schematic illustration in perspective view for defining planes and directions in a sea volume. FIG. 13 is a schematic view from above of a ship passing a sensor. The sensor of FIG. 13 is looking at the ship at right angle, which can be clearly seen, and the slice plane is vertical, which may be imagined.

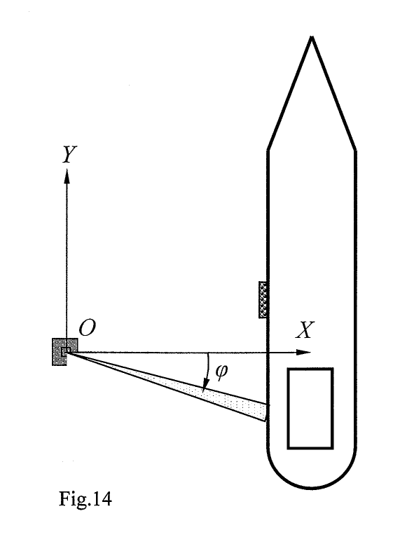

FIG. 14 is a schematic view from above to illustrate a definition of a sensor turn angle.

The inventors have foreseen an advantage of turning the sensor such that it looks at the passing vessel obliquely from behind or obliquely from the front. The slice plane is in this case oriented such that a projection of the normal vector of the slice plane in the sea surface plane is forming a turn angle φ (fi) to the projection of the (intended) velocity vector in the same plane. The turn angle may advantageously be in the interval of 0 to 30 degrees. The turn angle φ can also be expressed as the angel between an X-direction projection in the sea surface plane and of a projection in the sea surface plane of a beam of the slice plane, see FIG. 14.

More advantageously, the turn angle may be in the interval of 15 to 25 degrees, because objects extruding from the hull might be easier to detect since a shadow will appear behind the object resulting in higher contrast between object and hull.

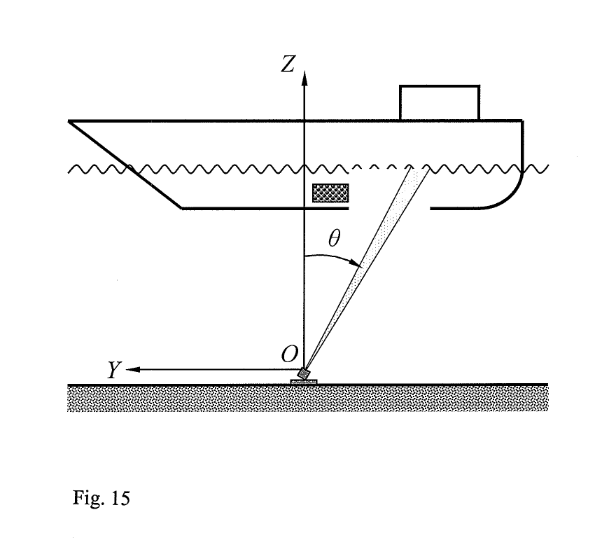

FIG. 15 is a schematic view from above to illustrate a definition of a sensor tilt angle. The inventors have foreseen an advantage arranging the sensor to tilt the plane of the sensor slice such that a tilt angle θ (theta) between the velocity vector, and the projection of the normal vector of the slice plane in a vertical plane parallel to the velocity vector, is in the range of 0 to 30 degrees, see FIG. 15.

It is predicted that a tilt angle (θ) in the range of 15 to 25 degrees, would be especially advantageous because the resolution of details in the Y-direction would increase as more beams from the sensor would be involved lengthwise the final image of the hull of the passing ship. The resolution in Y-direction is limited by the speed at which new slice images can be obtained. This may in turn be caused by the limited velocity of sound in water, approximately 1500 meter per second, which entail that the ship may move a certain distance while the sensor sound is travelling forth and back.

The inventors envisage that both a turn angle and a tilt angle should be applied simultaneously to give best possible resolution in both lengthwise and heightwise direction on the hull surface.

1-24. (canceled)

25. A hull inspection system useable for inspecting a hull of a maritime vessel passing a water volume at a first velocity, the system comprising:
pulse emitting means, for being placed in the water volume and for emitting energy pulses into said water volume;
sensing means, for being placed in the water volume, and being connected to the pulse emitting means, for sensing and measuring travelling time of energy pulses reflected by the passing vessel
a sensor data processing unit connected to the sensing means, for processing data from the sensor means;
a vessel data furnishing unit, connected to the sensor data processing unit, for providing vessel velocity data to the sensor data processing unit,
wherein:
a three-dimensional representation of the hull of the maritime vessel is created based on data acquired by a procedure involving combination of data from a number of consecutive sensing means linear scans; and
consecutive linear scans are acquired at consecutive moments in time, enabling a three dimensional representation of the hull to be built up.

26. The system of claim 25, wherein:
a first scanning direction is obtained by the passing of the maritime vessel by the position of the sensing means at the first velocity; and
a second scanning direction, different from the first scanning direction, is obtained by arranging the sensor unit to scan in the second scanning direction.

27. The system of claim 26 wherein a slice scanning plane, in which slice scanning plane the sensing is performed by the sensing means in the second scanning direction, is arranged to have a normal vector being parallel with a first velocity vector of the first velocity.

28. The system of claim 26 wherein a slice scanning plane, in which slice scanning plane the sensing is performed by the sensing means in the second scanning direction, is arranged to have a normal vector deviating from parallel with the first velocity vector with a first angle being up to 80 degrees in a first direction, and up to 80 degrees in a second direction.

29. The system of claim 28 wherein the projection of the normal vector of the slice scanning plane in the sea surface plane is arranged to form a turn angle (φ) to the projection of the (intended) velocity vector in the sea surface plane, the turn angle being arranged to be in the interval of 0 to 30 degrees.

30. The system of claim 29 wherein the turn angle (φ) is in the interval of 15 to 25 degrees.

31. The system according to claim 28 wherein a tilt angle (θ) between the velocity vector, and the projection of the normal vector of the slice scanning plane in a vertical plane parallel to the velocity vector, is arranged to be in the range of 0 to 30 degrees.

32. The system according to claim 31 wherein the tilt angle (θ) is in the range of 15 to 25 degrees.

33. The system of claim 25 wherein the emitter means and sensor means together is a sonar.

34. The system of claim 25 wherein the emitter means and sensor means together is a lidar.

35. The system of claim 25 further comprising a presentation unit for presenting processed data.

36. The system according to claim 25 wherein a representation of the water surface and the hull is built on a set of range values proportional to energy transit times from a energy pulse emitter to the water surface or hull surface, and back, and detected as strongest echo in each direction of a family of directions in a slice scanning plane.

37. A method for inspecting a hull of a maritime vessel passing a water volume at a first velocity, the method comprising the following steps:
emitting energy pulses into said water volume with the aid of an emitting means;
sensing and measuring travelling time of energy pulses reflected by the passing vessel with the aid of sensor means;
processing data from the sensor means;
providing vessel velocity data; and
creating a three-dimensional representation of the hull of the maritime vessel based on data acquired by a procedure involving a combination of data from a number of consecutive sensing means linear scans,
wherein the consecutive linear scans are acquired at consecutive moments in time.

38. The method of claim 37 wherein:
a first scanning direction is obtained by the passing of the maritime vessel by the position of the sensing means at the first velocity; and
a second scanning direction, different from the first scanning direction, is obtained by arranging the sensor means to scan in the second scanning direction.

39. The method of claim 38 wherein a slice scanning plane is arranged where sensing is performed by the sensing means in the second scanning direction, and a normal vector of which is arranged to be parallel with a first velocity vector of the first velocity.

40. The method of claim 38 wherein a slice scanning plane, in which slice scanning plane the sensing is performed by the sensing means in the second scanning direction, the slice scanning plane being arranged to have a normal vector deviating from parallel with the first velocity vector with a first angle being up to 80 degrees in a first direction, and up to 80 degrees in a second direction.

41. The method of claim 40 wherein the projection of the normal vector of the slice scanning plane in the sea surface plane is arranged to form a turn angle (φ) to the projection of the velocity vector in the sea surface plane, the turn angle being arranged to be in the interval of 0 to 30 degrees.

42. The method of claim 41 wherein the turn angle (φ) is in the interval of 15 to 25 degrees.

43. The method of claim 37 wherein a tilt angle (θ) between the velocity vector, and the projection of the normal vector of the slice scanning plane in a vertical plane parallel to the velocity vector, is arranged to be in the range of 0 to 30 degrees.

44. The method of claim 43 wherein the tilt angle (θ) is in the range of 15 to 25 degrees.

45. The method of claim 37 wherein the emitter means and sensor means are together arranged as a sonar.

46. The method of claim 37 wherein the emitter means and sensor means are together arranged as a lidar.

47. The method according to claim 37, further comprising a presentation unit for presenting processed data.

48. The method according to claim 37, wherein a representation of the water surface and the hull is built on a set of range values proportional to energy transit times from a energy pulse emitter to the water surface or hull surface, and back, and detected as strongest echo in each direction of a family of directions in a slice scanning plane.
